(19) United States
(12) Patent Application Publication
(10) Pub. No.: US 2015/0316928 A1
(43) Pub. Date: Nov. 5, 2015

(54) METHOD AND DEVICE FOR THE COMBINED SIMULATION AND CONTROL OF REMOTE-CONTROLLED VEHICLES

(71) Applicant: GRENZEBACH MASCHINENBAU GMBH, Asbach-Baeumenheim (DE)

(72) Inventors: Olaf GUEHRING, Eurasburg (DE); Holger SCHMIDT, Freising (DE)

(73) Assignee: Grenzebach Maschinenbau GMBH, Asbach-Baeumenheim (DE)

(21) Appl. No.: 14/439,975

(22) PCT Filed: Nov. 11, 2013
(86) PCT No.: PCT/DE2013/000674

§ 371 Date: Apr. 30, 2015

(30) Foreign Application Priority Data
Nov. 16, 2012 (DE) 10 2012 022 472.9

(51) Int. Cl. G05D 1/00; B64C 39/02; G09B 9/48

(52) U.S. Cl. CPC G05D 1/0038; G09B 9/48; B64C 39/024

(57) ABSTRACT

The invention relates to a device and a method for the combined simulation and control of remote-controlled vehicles in a simulator. A driver's/pilot's compartment comprising real operating elements and emulating the vehicle to be controlled is provided with a six-axis industrial robot connected to ground via a support system that can be designed. as an undercarriage. A display emulating the contours of the driver's/pilot's compartment serves to convey a simulated view of the exterior. The invention is characterized by the following: a) a receiving unit for receiving optical data of the vehicle to be controlled, b) a receiving unit for receiving acoustic data of the vehicle to be controlled, c) a transmitting and receiving unit, for the bidirectional transmission of motion-relevant data, d) a control unit which uses mathematical models to process any signals that are mechanically produced by the user of the simulator, and transmits them to the controls of the vehicle, and e) a sensor unit mounted in the head region of the user for detecting the position of the head, the data thereof influencing the gaze direction and/or the image perspective shown on the display.

The invention relates to a method and a device for the combined simulation and control of remote-controlled vehicles.

Flight simulators or vehicle simulators increase safety and reduce the costs of training for a real-life flight. The safety aspects are improved when inexperienced trainee pilots are learning to fly or pilots with little experience are being instructed about operational procedures in connection with new vehicles or new techniques.

DE 10 2010 035 814 B3, which originates from the applicant itself, discloses a device and a method for operating a particularly realistic flight simulator.

The device described there and the corresponding method are based on the object of presenting a device and a method with which the operation of a particularly realistic simulator for learning to control a vehicle, in particular a flying machine, moving in three-dimensional reality can be achieved. It is also intended to be possible for the trainer in attendance during the learning process to be able to monitor the learning progress and. exertion of his pupil objectively.

To achieve this object, according to patent claim 1, a device for operating a particularly realistic simulator for learning how to control a vehicle moving in three-dimensional reality is claimed, a vehicle cabin that replicates the flying machine to be simulated with real-life operating elements comprising a 6-axis industrial robot which is connected to the ground by way of a supporting device that may be designed as an undercarriage, and a display that replicates the contours of the vehicle cabin serving for the transmission of a simulated outside view. This device is characterized, in that it has the following features:
a) in addition to the connection to the 6-axis industrial robot (1), the vehicle cabin (4) is connected to the ground by way of a device (6) for translational transverse movement, which is mounted movably at right angles on a device (5) for translational longitudinal movement, combined accelerated movements of the two devices (6, 5) being made possible, independently of the movements of the industrial robot (1),
b) the display replicating the contours of the vehicle cabin (4) is produced on the basis of OLED technology,
c) controllable installations for generating artificial smoke (12), shaking movements, generating sound and light effects (14) are provided to simulate hazardous situations that occur in practice,
d) controllable installations for sensing the skin resistance (10) and detecting personal movements and physiognomy (16) are provided for sensing human stress reactions,
e) a sensor (17) for sensing the actual movements of the vehicle cabin,
f) an installation for externally operating and controlling the simulator, which also registers the reactions of a trainee pilot.

Furthermore, DE 10 2010 053 686 B3, likewise from the applicant, discloses an autonomous safety system for the users of vehicle simulators or flight simulators and a method for the safe use of such simulators. These are based on the object of presenting a device and a method with which not only the imparting of technical knowledge on the operation of vehicles or aircraft but also the safety of the user of a flight simulator in the event of a technical fault or an accident is a priority.

In patent claim 1, the following is claimed in this respect:

An autonomous safety system for the use of vehicle simulators or flight simulators in the form of a simulation cockpit (3) actuated by means of a 6-axis robot, with the following features:
a) an access area, open only to authorized persons and multiply secured by means of monitoring sensors (11) at all the corners of a safety-confinement (9),
b) a rescue unit (13), which can move on a running rail (14) to every location of the operational area of the vehicle simulator, this rescue unit having a rescue platform (25), a railing (24) and a rescue chute (26),
c) a shock-absorbent, surface installed in the entire operational area, this shock-absorbent surface extending over the entire operational area of the cockpit (3),
d) a projection area (33, 34) made up of multiple levels.

Nevertheless, even if seeming to be very realistic, the operating data transmitted into the vehicle cabin for the respective simulation operation are different from the operating data such as occur during real-life operation of a vehicle. This is so because a real-life pilot consciously or subconsciously senses far more with his human senses than is normally simulated in a vehicle cabin. This becomes particularly clear in the cases in which autonomous flying machines, known as drones, are controlled by pilots who actually instigate genuine flying maneuvers.

The present invention is therefore based on the object of presenting a device and a method for simulating vehicle movements with which the degree of realism for the respective pilot is increased significantly, in particular with respect to vehicle movements actually taking place.

This object is achieved by the features of claim 1
a device for the combined simulation and control of remote-controlled vehicles in a simulator, a vehicle cabin that replicates the vehicle to be controlled with real-life operating elements comprising a 6-axis industrial robot which is connected to the ground, by way of a supporting device that may be designed as an undercarriage, and a display that replicates the contours of the vehicle cabin serving for the transmission of a simulated outside view,
characterized in that it has the following features:
   a) a receiving unit for receiving optical data of the vehicle to be controlled
   b) a receiving unit for receiving acoustic data of the vehicle to be controlled,
   c) a transmitting and receiving unit for the bidirectional transmission of movement-relevant data,
   d) a control unit, which transmits signals mechanically generated by the user of the simulator, processed by means of mathematical models, to the controls of the vehicle,
   e) a sensor unit, installed, in the head area of the user, for sensing the position of the head, the data of which influencing the viewing direction and/or the viewing perspective that is displayed on the display;
claim 2:
   the device as claimed in claim 1,
   characterized
   in that the control may be used for vehicles on land, at sea and in the air;
claim 3:
   the device as claimed in claim 1, 2 or 3,
   characterized
   in that a receiving unit for receiving olfactory and/or taste-specific data is provided;
and a corresponding method as claimed in claim 4
   a method for the combined simulation and control of remote-controlled vehicles in a simulator, a vehicle cabin that replicates the vehicle to be controlled with real-life operating elements comprising a 6-axis industrial robot which is connected to the ground by way of a supporting device that may be designed as an undercarriage, and a display that replicates the contours of the vehicle cabin serving for the transmission of a simulated outside view,
   characterized in that it has the following features:
      a) current data, determined by sensors, from the areas of optics, movement kinematics and acoustics are transmitted to the user of the simulator from the vehicle to be controlled,
      b) the user of the simulator consequently receives virtually the same impression of the process involved in the movement of the vehicle as a pilot in real life and can react to an actual situation according to his experience and/or intuition,
      c) the manner of the reaction of the user of the simulator is converted into mechanically picked-up signals, processed by means of mathematical models, transmitted to the vehicle to be controlled and converted there into real-life control processes,
      d) a sensor unit installed in the head area of the user is provided for sensing the position of the head, its data influencing the viewing direction and/or the viewing perspective that is displayed on the display;
claim 5:
   the method, as claimed in claim 4,
   characterized
   in that the control can be used for vehicles on land, at sea and in the air;
claim 6:
   the method as claimed in either of vehicles 4 and 5,
   characterized
   in that the transmission of olfactory and/or taste-specific data from the vehicle is provided;
claim 7:
   a computer program with a program code for carrying out the method, steps as claimed in one of claims 4 to 7 when the program is run in a computer;
claim 8:
   a machine-readable carrier with the program code of a computer program for carrying out the method as claimed in one of claims 4 to 7 when the program is run in a computer.

The invention is based on the idea of using the transmission of important data from a vehicle moving in real life to enable the user to feel as though he were actually the pilot of the respective vehicle. All vehicles that are commonly used on land, at sea and in the air apply as vehicles in the sense of the present invention.

The invention is described in more detail below.

Since aircraft are clearly most difficult to control and keep in the air, the invention is described by using the example of aircraft. Even in the civil area, unmanned aircraft systems are increasingly taking over the air space. Thus, such flying objects are even mentioned in the final version of the new air traffic act for Germany. These flying objects, usually known as drones in the military area, can fly to locations that a person only reaches with difficulty and are usually cheaper and safer than helicopters. In comparison with satellites, they have the advantage that they can not only fly to and investigate specific locations directly and closer, but can also keep doing so until the desired result is achieved.

However, the payload for commonly used flying objects of this type is restricted, and therefore their area of use is still somewhat restricted.

Larger unmanned aircraft systems of this type would however currently still require a pilot, the weight of whom however is in turn a negative factor. Apart from this, even in the civil area, there are operations that may result in the loss of human life.

This problem is solved according to the invention by already existing flight simulators such as those mentioned in the introductory part of the description being additionally provided with units that are equipped for receiving data from vehicles to be controlled, for example from unmanned aircraft systems. In this way, the user of such a simulator is enabled to obtain, virtually in real time, flight data required for controlling a vehicle in real-life movement. In order to send correction data that is however necessary for such active control to the flying object to be controlled, it is additionally provided that movement-relevant data are sent to the flying object, as it were in a bidirectional way, by means of a transmitting station arranged in the area of the simulator.

Such movement-relevant data are generated by means of mechanical signals that the user of the simulator generates by means of conventionally actuated pedals or side sticks and, processed by means of suitable mathematical models or operations, are sent to the controls of the respective vehicle. The experience of a simulator pilot, and similarly a certain intuition gained from experience, are reflected in these signals being generated at the right time and correctly.

The data sent from the vehicle to be controlled, which are of an optical, acoustic or situation-dependent character, only require a bidirectional form to the extent that in this way data of this kind are requested at certain intervals or constantly.

A sensor unit installed in the head area of the user is provided for sensing the position of the head, the data of which influencing the viewing direction and/or the viewing perspective that is displayed on the display or the projection wall.

The control of the complex movement processes and the signal processing of the sensors used require a special control program.

1. A device for the combined simulation and control of remote-controlled vehicles in a simulator, a vehicle cabin that replicates the vehicle to be controlled with real-life operating elements comprising a 6-axis industrial robot which is connected to the ground by way of a supporting device feat may be designed as an undercarriage, and a display that replicates the contours of the vehicle cabin serving for the transmission of a simulated outside view,
wherein said device comprises the following features;
a) a receiving unit for receiving optical data of the vehicle to be controlled
b) a receiving unit for receiving acoustic data of the vehicle to be controlled,
c) a transmitting and receiving unit for the bidirectional transmission of movement-relevant data,
d) a control unit, which transmits signals mechanically generated by the user of the simulator, processed by means of mathematical models, to the controls of the vehicle,
e) a sensor unit, installed In the head area of the user, for sensing the position of the head, the data of which influencing the viewing direction and/or the viewing perspective that is displayed on the display.

2. The device as claimed in claim 1, wherein the control may be used for vehicles on land, at sea and in the air.

3. The device as claimed in claim 1, wherein a receiving unit for receiving olfactory and/or taste-specific data is provided.

4. A method for the combined simulation and control of remote-controlled vehicles in a simulator, a vehicle cabin that replicates the vehicle to be controlled with real-life operating elements comprising a 6-axis industrial robot which is connected to the ground by way of a supporting device that may be designed as an undercarriage, and a display that replicates the contours of the vehicle cabin serving for the transmission of a simulated outside view,
wherein the method comprises the following features:
a) current data, determined by sensors, from the areas of optics, movement kinematics and acoustics are transmitted to the user of the simulator from the vehicle to be controlled,
b) the user of the simulator consequently receives virtually the same impression of the process involved in the movement of the vehicle as a pilot in real life and can react to an actual situation according to his experience and/or intuition,
c) the manner of the reaction of the user of the simulator is converted into mechanically picked-up signals, processed by means of mathematical models, transmitted to the vehicle to be controlled and converted there into real-life control processes,
d) a sensor unit installed in the head area of the user is provided for sensing the position of the head, its data influencing the viewing direction and/or the viewing perspective that is displayed on the display.

5. The method as claimed in claim 4, wherein the control can be used for vehicles on land, at sea and in the air.

6. The method as claimed in claim 4, wherein the transmission of olfactory and/or taste-specific data from the vehicle is provided.

7. A computer program with a non-transitory program code for carrying out the method steps as claimed in claim 4 when the program is run in a computer.

8. A machine-readable carrier with the non-transitory program code of a computer program for carrying out the method as claimed in claim 4 when the program is run in a computer.
